(19) United States
(12) Patent Application Publication
(10) Pub. No.: US 2010/0163373 A1
(43) Pub. Date: Jul. 1, 2010

(54) MEDICAMENT BOTTLE DISPENSER

(75) Inventors: Timothy A. Giebler, Olathe, KS (US); Ron Leonard, Peculiar, MO (US); Keith Kudera, Merriam, KS (US)

Correspondence Address: HOVEY WILLIAMS LLP, 10801 Mastin Blvd., Suite 1000, Overland Park, KS, 66210, US

(73) Assignee: SCRIPTPRO LLC, Mission, KS (US)

(21) Appl. No.: 12/346,474

(22) Filed: Dec. 30, 2008

(51) Int. Cl. B65G 29/00; B65G 1/16

(52) U.S. Cl. 198/803.16; 414/288

(57) ABSTRACT

A bulk loading medicament bottle dispenser comprises a hopper and a medicament bottle dispenser. The hopper includes a ramped shelf and a bin and is configured to receive a plurality of medicament bottles from an external source and roughly align the plurality of medicament bottles to be picked up one at a time. The medicament bottle dispenser includes at least one pick arm, a pick wheel, a chute, a pickup platform, and a gating mechanism. The pick arm is coupled to the pick wheel and may pick up and retain a first medicament bottle from the plurality of medicament bottles as the pick wheel rotates. The chute may receive the first medicament bottle from the pick arm and may pass the first medicament bottle to the pickup platform. However, the gating mechanism may retain the first medicament bottle in the chute if there is already a second medicament bottle present on the pickup platform.

### BACKGROUND OF THE INVENTION

1. Field of the Invention

Embodiments of the present invention relate to an apparatus for rapidly orienting and dispensing open-top medicament bottles, especially in the context of automated medicament filling equipment. More particularly, embodiments of the present invention relate to a bulk loading medicament bottle dispenser that rapidly orients irregular-shaped bottles and maintains a supply of bottles to be dispensed.

2. Description of the Related Art

A medicament bottle dispenser is usually part of a larger medicament dispensing system that may receive a large volume of bottles and fill each bottle with medicaments to be distributed to a consumer. An exemplary environment where the medicament dispensing system may be used is a pharmacy, where a patient may receive a bottle filled with prescription, or non-prescription, medication.

The medicament bottle dispenser usually receives the bottles in a bulk load, where each bottle is in a random orientation. The dispenser generally presents the bottles in an upright fashion to the next stage of the medicament dispensing system which may fill the bottles with medicaments. However, traditional implementations of the dispenser may not be synchronized with the rest of the medicament dispensing system.

In some systems, the medicament dispensing system may fill the bottles with pills at a slower rate than the dispenser is feeding it. In order to avoid an overflow of bottles from the dispenser, the dispenser may be adjusted to run at a less than optimal speed.

In other systems, the medicament dispensing system may fill the bottles faster than the dispenser is feeding it. Thus, one or more stages of the medicament dispensing system may be idle while they wait for a bottle to be dispensed. In either case, the medicament dispensing system is performing inefficiently, with either the dispenser or other portions of the medicament dispensing system operating below their capabilities.

In addition, conventional medicament dispensing systems generally handled uniform cylindrical-shaped bottles. While the dispenser could present the bottles to the next stage of the system in a generally upright position, they often don't properly orient an oblong or otherwise non-uniform shaped bottle. Thus, specialized bottles may be mishandled by the medicament dispensing system, resulting in improper filling of the bottles.

### SUMMARY OF THE INVENTION

Embodiments of the present invention solve the above-mentioned problems and provide a distinct advance in the art of a bulk loading medicament bottle dispenser. More particularly, embodiments of the invention provide a medicament bottle dispenser that maintains a supply of bottles to be dispensed, thereby providing synchronization between the bottle dispenser and subsequent stages, such as a bottle filling stage, of a medicament dispensing system. Furthermore, the medicament bottle dispenser may orient an oblong or otherwise non-uniform shaped bottle to be properly retrieved and handled by subsequent stages of the medicament dispensing system.

In various embodiments, the medicament bottle dispenser may comprise a hopper and a bottle pickup assembly. The hopper may include a bin with a ramped shelf and is configured to receive a plurality of medicament bottles from an external source and roughly align the medicament bottles to be picked up one at a time. The ramped shelf may direct the medicament bottles toward a pickup area in the bin, which may retain the medicament bottles until they are picked up by the bottle pickup assembly.

The bottle pickup assembly includes a pick wheel, at least one pick arm mounted to the pick wheel, a chute, a pickup platform, and a gating mechanism. The pick arm is coupled to the pick wheel and may pick up and retain a first medicament bottle from the plurality of medicament bottles as the pick wheel rotates. The chute may receive the first medicament bottle from the pick arm and may pass the first medicament bottle to the pickup platform. The bottle pickup assembly may further include a first sensor to detect the presence of any medicament bottle on the pickup platform. The gating mechanism may retain the first medicament bottle in the chute if the first sensor detects a second medicament bottle present on the pickup platform. Furthermore, the pick wheel may stop rotating if the second medicament bottle is present on the pickup platform, the first bottle is present in the chute, and a third bottle is retained on the pick arm approaching the chute.

In various other embodiments, the pickup platform may include a rotating unit to properly orient a non-uniform shaped medicament bottle while the medicament bottle is on the pickup platform. The rotating unit may include a turntable, a drive motor, and a second sensor. The turntable may be rotated while retaining the medicament bottle. The drive motor may rotate the turntable at least once to identify an alignment feature present on the medicament bottle. The second sensor may identify the alignment feature such that the medicament bottle may be rotated to the proper orientation.

This summary is provided to introduce a selection of concepts in a simplified form that are further described below in the detailed description. This summary is not intended to identify key features or essential features of the claimed subject matter, nor is it intended to be used to limit the scope of the claimed subject matter.

Other aspects and advantages of the present invention will be apparent from the following detailed description of the embodiments and the accompanying drawing figures.

### BRIEF DESCRIPTION OF THE DRAWING FIGURES

Embodiments of the present invention is described in detail below with reference to the attached drawing figures, wherein:

FIG. 1 is a perspective view of a medicament bottle dispenser constructed in accordance with various embodiments of the present invention;

FIG. 2 is a top plan view of the lower portion of the dispenser with a ramped shelf removed to expose the components below;

FIG. 3 is a sectional view of the right-half portion of the dispenser cut along a vertical plane through a front wall and a rear wall;

FIG. 4 is a sectional view of the forward portion of the dispenser cut along line 4-4 of FIG. 3 through a left side wall and a right side wall;

FIG. 5 is a perspective view of the forward section of the dispenser as seen taken from a cut similar to line 4-4 of FIG. 3;

FIG. 6 is a fragmentary perspective view of the dispenser highlighting a gating mechanism;

FIG. 7 is a front elevational view with the front wall removed to depict a first aspect of the operation of the dispenser;

FIG. 8 is a front elevational view with the front wall removed to depict a second aspect of the operation of the dispenser;

FIG. 9 is a front elevational view with the front wall removed to depict a third aspect of the operation of the dispenser;

FIG. 10 is a perspective view of a rotating unit used with the dispenser;

FIG. 11 is a perspective exploded view of the rotating unit;

FIG. 12 is a top plan view of the rotating unit;

FIG. 13 is a sectional view of the rotating unit cut along line 13-13 of FIG. 12;

FIG. 14 is a perspective view of a bottle which is handled by the dispenser; and

FIG. 15 is a block diagram of various components of the dispenser.

The drawing figures do not limit the present invention to the specific embodiments disclosed and described herein. The drawings are not necessarily to scale, emphasis instead being placed upon clearly illustrating the principles of the invention.

### DETAILED DESCRIPTION OF THE EMBODIMENTS

The following detailed description of the invention references the accompanying drawings that illustrate specific embodiments in which the invention can be practiced. The embodiments are intended to describe aspects of the invention in sufficient detail to enable those skilled in the art to practice the invention. Other embodiments can be utilized and changes can be made without departing from the scope of the present invention. The following detailed description is, therefore, not to be taken in a limiting sense. The scope of the present invention is defined only by the appended claims, along with the full scope of equivalents to which such claims are entitled.

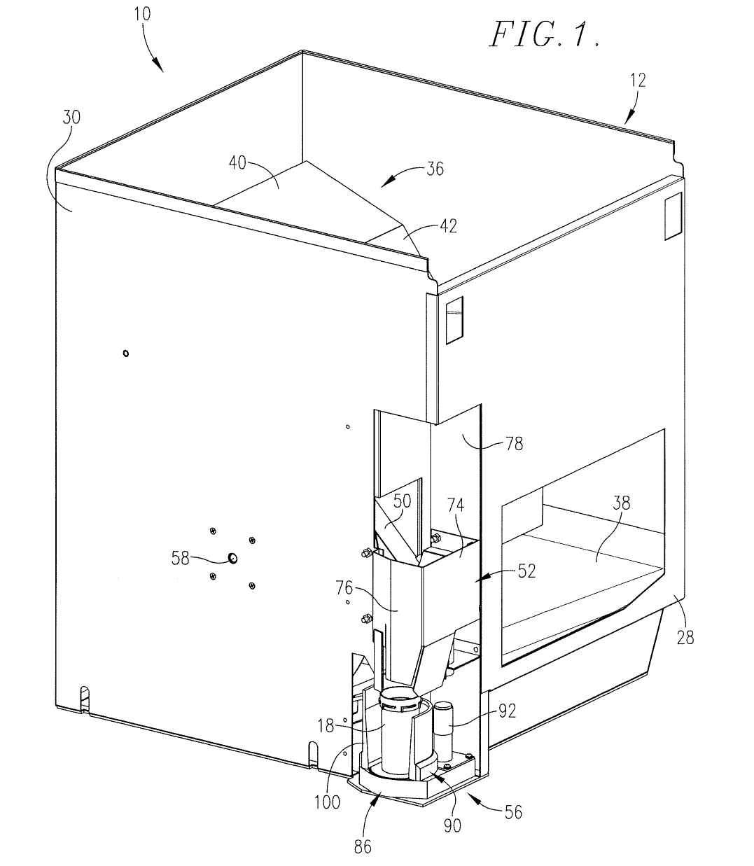

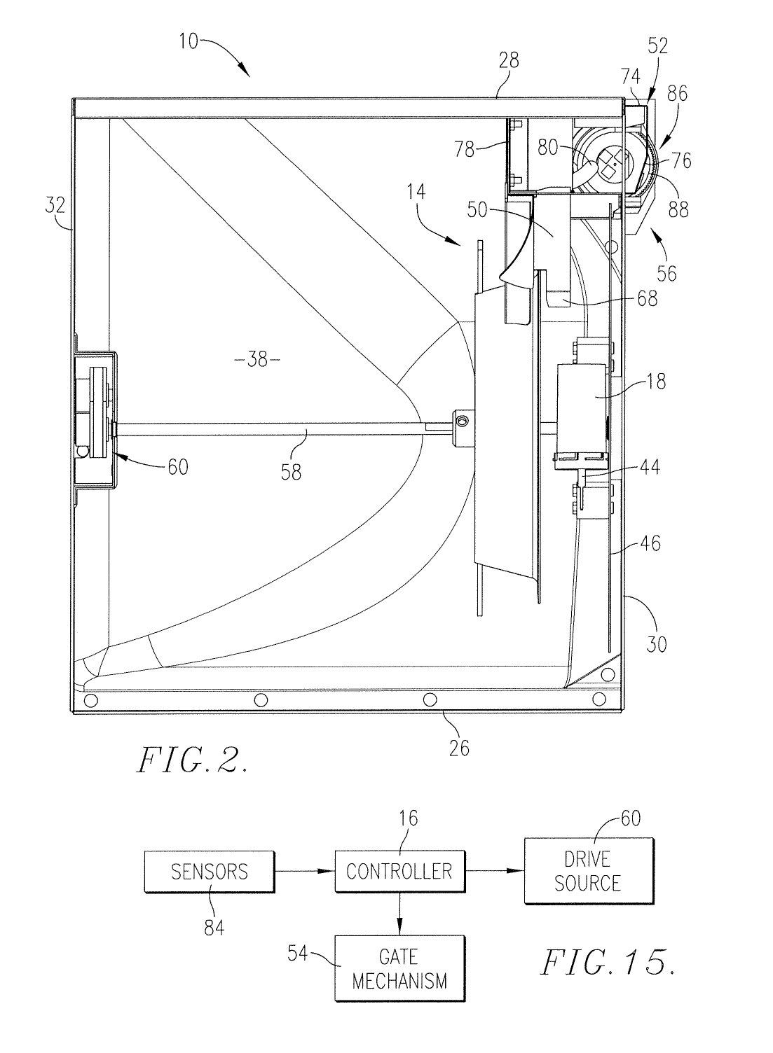

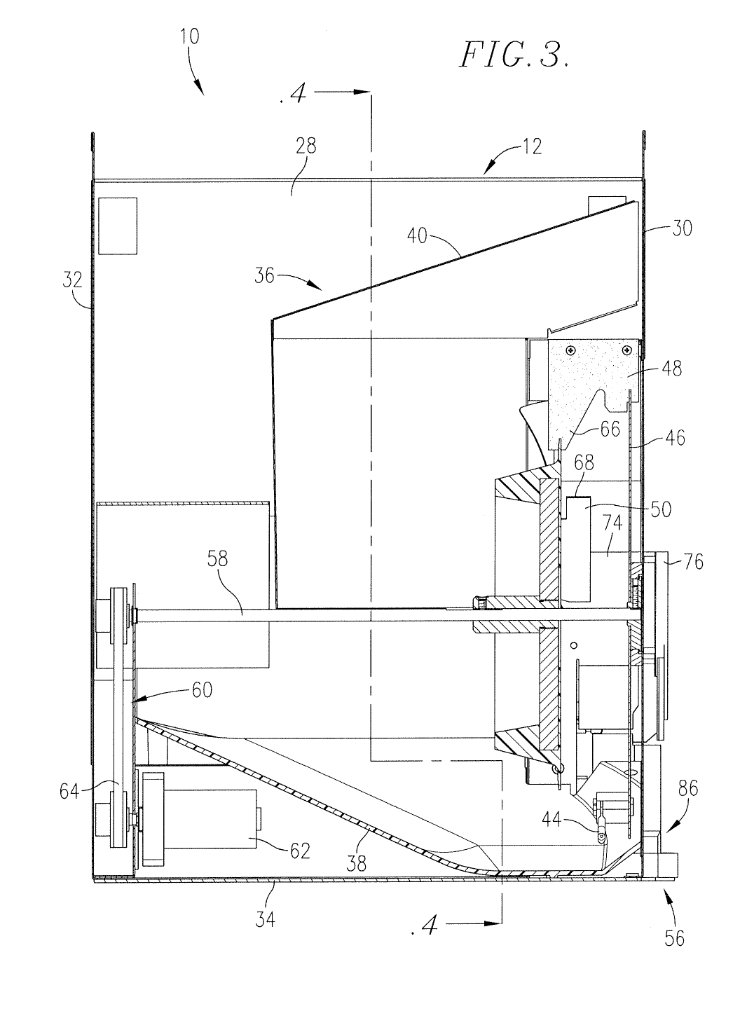

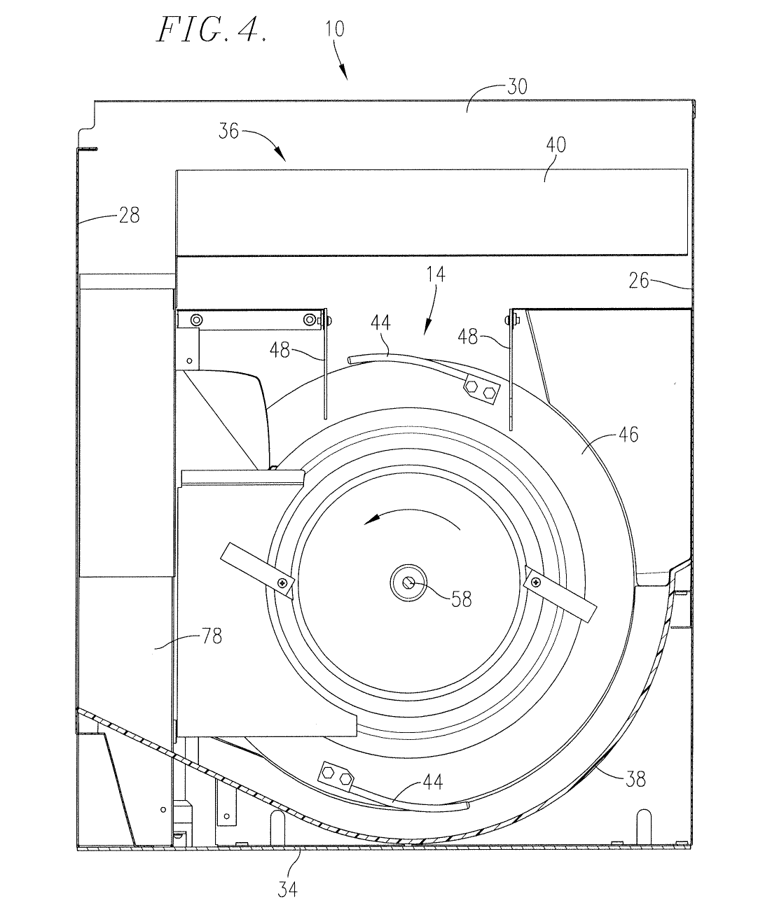

An improved bulk loading medicament bottle dispenser 10 constructed in accordance with various embodiments of the present invention is shown in FIGS. 1-9. The dispenser 10 broadly comprises a hopper 12, a bottle pickup assembly 14, and a controller 16. The hopper 12 generally receives a plurality of medicament bottles 18 in a bulk load from an external source and roughly aligns the bottles 18 such that the bottle pickup assembly 14 may pick the bottles 18 one at a time. The bottle pickup assembly 14 then presents the bottles 18 in the proper orientation to be retrieved by an external stage of a system and filled with selected medicaments. The bottle pickup assembly 14 presents a new bottle 18 only when the previously picked bottle 18 has been retrieved and maintains a supply of bottles 18 to be dispensed.

The bottles 18 are generally conventional medicament bottles that are roughly cylindrical in shape with a bottom wall 20 and a circumscribing wall 22, as seen in FIG. 14. In order to receive medicaments, the bottles 18 are typically open-topped. In various embodiments, the circumscribing wall 22 of the bottle 18 may have an oblong or oval cross-sectional shape, such that the bottle 18 may have a particular orientation about its longitudinal axis. These bottles 18 may also include an alignment feature 24 to help identify an orientation. In certain embodiments, the alignment feature 24 may include rib-like protrusions on the bottom of the bottle 18.

The hopper 12 is generally of rectangular box shape with an open top as well as a left side wall 26, a right side wall 28, a front wall 30, a rear wall 32, and a bottom wall 34, as seen at least in part in FIGS. 1-5. The hopper 12 further includes an inner ramped shelf 36 and a bin 38. The shelf 36 is coupled to the interior of the front wall 30 and the left side wall 26 and is positioned in the upper half of the hopper 12. The shelf 36 includes a shallow ramp 40 that is inclined toward a steep ramp 42 which in turn is inclined sharply downward toward the bin 38, over which the steep ramp 42 is located.

The bin 38 is roughly rectangular in shape and includes curved edges that couple with the interior of the rear wall 32, the left side wall 26, and the right side wall 28 at a height above the bottom wall 34. The bin 38 angles downward toward the center of the bottom wall 34 from the left side wall 26 and the right side wall 28. The bin 38 also angles downward as it approaches the front wall 30, where it couples with the bottle pickup assembly 14.

The bottle pickup assembly 14 may include a plurality of pick arms 44, a pick wheel 46, a plurality of flaps 48, a dispenser ramp 50, a chute 52, a gating mechanism 54, and a pickup platform 56, as seen at least in part in FIGS. 5-9. The pick arm 44 is generally elongated and roughly rod-shaped with a slight curvature, wherein one end of the pick arm 44 is coupled to the pick wheel 46 and the opposite end is free. The pick arm 44 is coupled to the pick wheel 46 such that the longitudinal axis of the arm 44 is parallel to the plane of the wheel 46 and such that the arm 44 is positioned at a distance away from the wheel 46. The offset distance may be related to the radial dimension of the bottles 18 that will be dispensed by the dispenser 10. The pick arm 44 may generally have any elongated shape and size such that one end of the pick arm 44 is able to be inserted into a bottle 18 and retain the bottle 18 on the arm 44 while the pick wheel 46 rotates. If the bottle pickup assembly 14 includes more than one pick arm 44, the pick arms 44 are evenly distributed about the circumference of the pick wheel 46 and are positioned close to the outer edge of the wheel 46. For example, if the bottle pickup assembly 14 includes two pick arms 44, the arms 44 are positioned roughly 180° apart from each other near the edge of the wheel 46.

The pick wheel 46 is generally disk shaped. The lower portion of the circumference of the pick wheel 46 may abut the forward edge of the bin 38 such that there is very little gap between the pick wheel 46 and the bin 38. The center of the pick wheel is coupled to one end of a drive shaft 58. The other end of the drive shaft 58 is coupled to a drive source 60. The drive source 60 may be generally located within the hopper 12. In various embodiments, the drive source 60 may include a motor 62 with one or more rollers that couple to the drive shaft 58 with a belt 64, such that rotation of the motor 62 produces rotation of the drive shaft 58 and in turn the pick wheel 46. In other embodiments, the drive source 60 may include a motor 62 that is directly coupled to the drive shaft 58 or perhaps is coupled to the drive shaft 58 through one or more gears. Other embodiments of the drive source 60 are possible, as long as they provide rotation to the drive shaft 58 and the pick wheel 46. Furthermore, the drive source 60 may rotate the pick wheel 46 based on an electrical or electronic signal from the controller 16.

The flaps 48 generally help to fully secure a single bottle 18 onto the pick arm 44 as the wheel 46 rotates. In addition, the flaps 48 may knock off, push off, or otherwise remove extra bottles 18 from the arm 44 or any single bottle 18 that is not properly oriented on the pick arm 44. Each flap 48 may be relatively thin, and of adequate stiffness to remove improperly positioned bottles 18 from the pick arm 44 but further secure properly positioned bottles 18 and allow them to continue rotating. Each flap 48 may also include a centrally-located cutout to allow the pick arm 44 to pass through the flap 48 and an elongated tab 66 to aid in the bottle 18 removal process. The flaps 48 may be positioned near the top of the rotation of the pick wheel 46 to further take advantage of the possibility that bottles 18 which are poorly positioned on the pick arm 44 may be ready to fall off and would thus be easier to knock off.

The dispenser ramp 50 generally allows passage of the bottle 18 from the pick arm 44 to the chute 52. The dispenser ramp 50 is generally elongated and sloped at a roughly 45° angle and may include a short stub 68 at one end that is roughly horizontal. The dispenser ramp 50 is positioned along the downward path of the pick arm 44 as the pick wheel 46 rotates. As the bottle 18 starts to descend after reaching the apex of the pick wheel 46, the bottle 18 may encounter the stub 68 and be guided off of the pick arm 44 and down the dispenser ramp 50. The dispenser ramp 50 is positioned at a distance away from the pick wheel 46 such that the pick arm 44 does not encounter or contact the dispenser ramp 50 as the pick wheel 46 rotates.

The chute 52 generally catches the bottle 18 as the bottle 18 descends the dispenser ramp 50 and guides the bottle 18 toward the gating mechanism 54. The chute 52 may include an open top and an open bottom, along with a first side wall 70, a second side wall 72, a third side wall 74, and a fourth side wall 76. The first side wall 70 may be positioned beneath the dispenser ramp 50. The second side wall 72 may be coupled to a vertically extending frame 78 that itself is coupled to the bottom wall 34 of the hopper 12. The third side wall 74 may abut the right side wall 28 of the hopper 12. And the fourth side wall 76 may abut the front wall 30 of the hopper 12. The lower portion of the second side wall 72 and the third side wall 74 are tapered inward toward the center of the chute 52. The lower portion of the first side wall 70 is angled outward away from the center of the chute 52. This tapered and angled structure guides the bottle 18 within the chute 52 such that the bottom of the bottle 18 aligns with the gating mechanism 54.

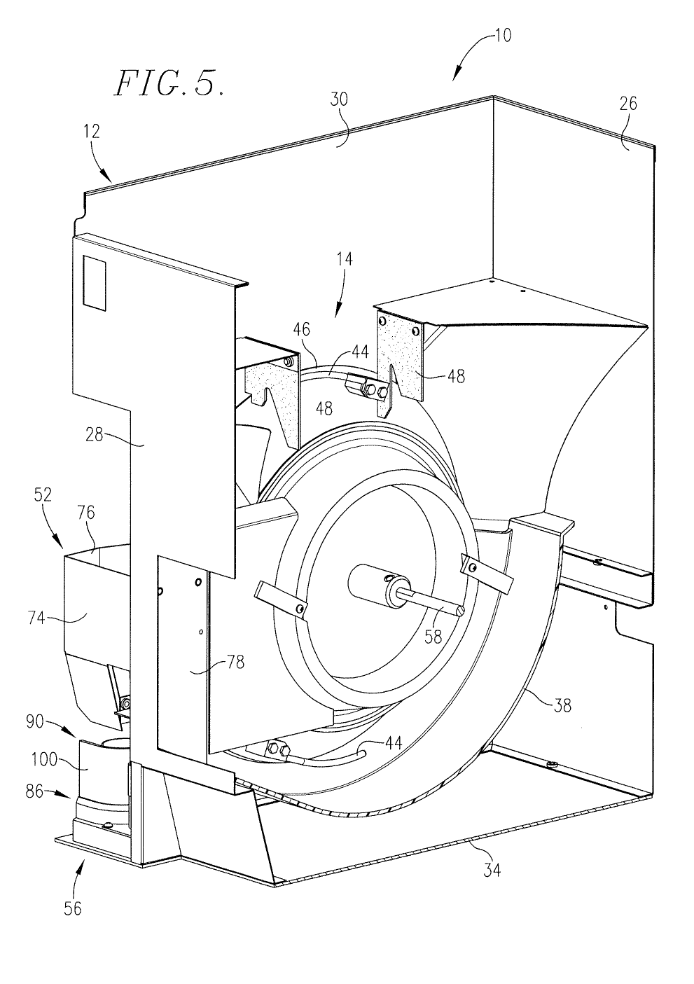

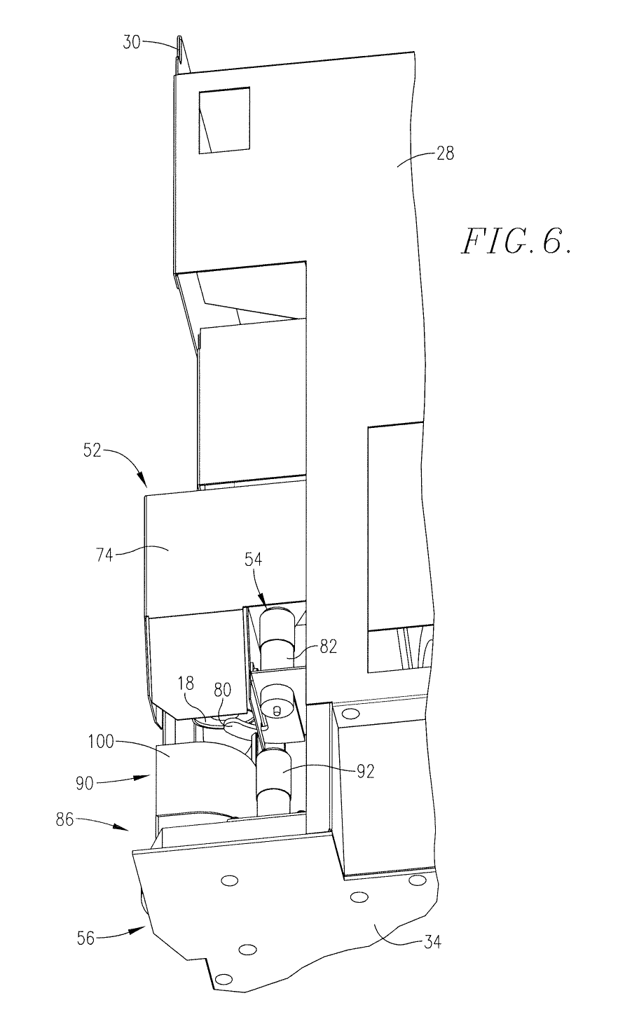

The gating mechanism 54 generally allows the bottle 18 to fall from the chute 52 to the pickup platform 56. The gating mechanism 54 may include a gate arm 80 and a gate driver 82, as best seen in FIG. 6. The gate arm 80 may be coupled to the gate driver 82 such that the gate driver 82 can extend and retract the gate arm 80. The gate arm 80 may be of any shape and dimension that can easily be extended into and retracted from the path of the bottle 18 as it passes through the chute 52. Typically, the gate arm 80 may be flat, thin, and elongated. In some embodiments, the gate arm 80 may be curved or hook shaped. The gate driver 82 may be any device or apparatus that can physically move the gate arm 80 from an extended position to a retracted position and back. The gate driver 82 may include one or more motors, particularly servo motors, solenoids, or similar rotating or translating devices. Furthermore, the gate driver 82 may receive an electrical or electronic signal from the controller 16 to extend and/or retract the gate arm 80.

The gating mechanism 54 may be positioned next to the chute 52. In various embodiments, the gating mechanism 54 may be positioned just outside the second side wall 72 of the chute 52 such that the gate arm 80 may protrude into the interior of the chute 52. In the extended position, the gate arm 80 extends into the chute 52 and blocks the path of the bottle 18, which retains the bottle 18 within the chute 52. In the retracted position, the gate arm 80 withdraws from the interior of the chute 52 to allow the bottle 18 to freely pass through the chute 52 to the pickup platform 56 below.

The pickup platform 56 generally retains the bottles 18 one at a time until the bottle 18 has been removed from the platform 56 and retrieved for medicament filling by an external entity. The pickup platform 56 may be located at the corner of the front wall 30 and the right side wall 28 and may be placed on or otherwise coupled to the bottom wall 34.

The pickup platform 56 may include a first sensor 84 to sense the presence of a bottle 18 on the platform 56. The first sensor 84 may send a signal to the controller 16 as to whether a bottle 18 is present or absent from the pickup platform 56. The first sensor 84 may include any device or mechanism, such as transducers or the like, that can detect the presence of a bottle 18. However, typically the first sensor 84 may include one or more optical transmitting and receiving devices. The optical transmitters may transmit an optical signal upward from the pickup platform 56. The optical receivers may receive a reflected optical signal if a bottle 18 is present on the pickup platform 56. The optical devices may include such optical components as lasers, light-emitting diodes (LEDs), photodetectors, photodiodes, and the like.

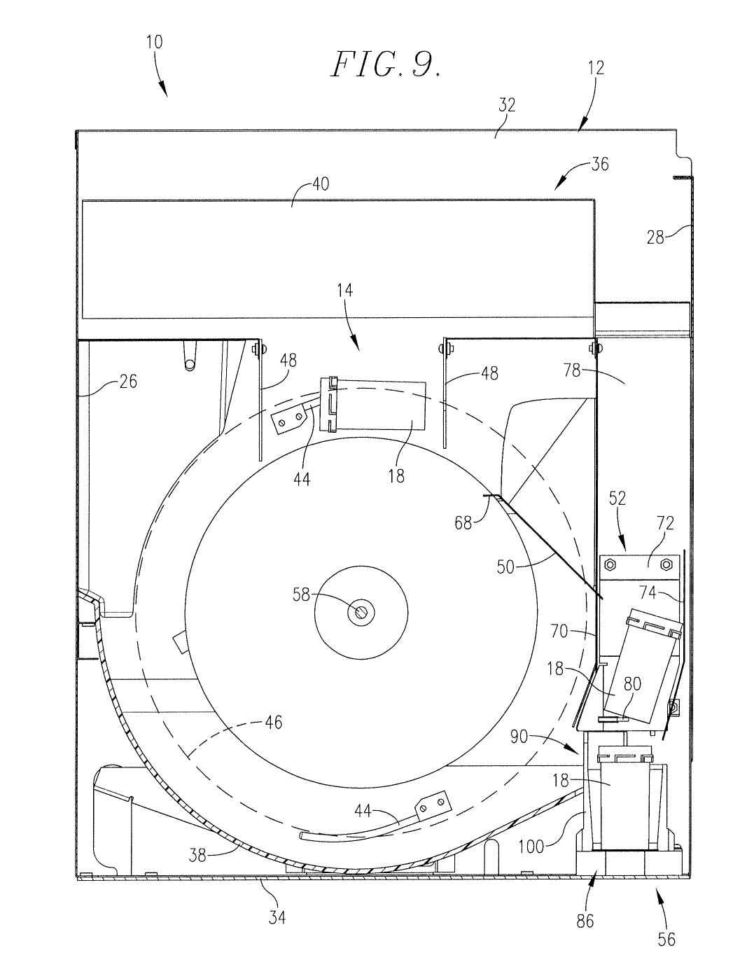

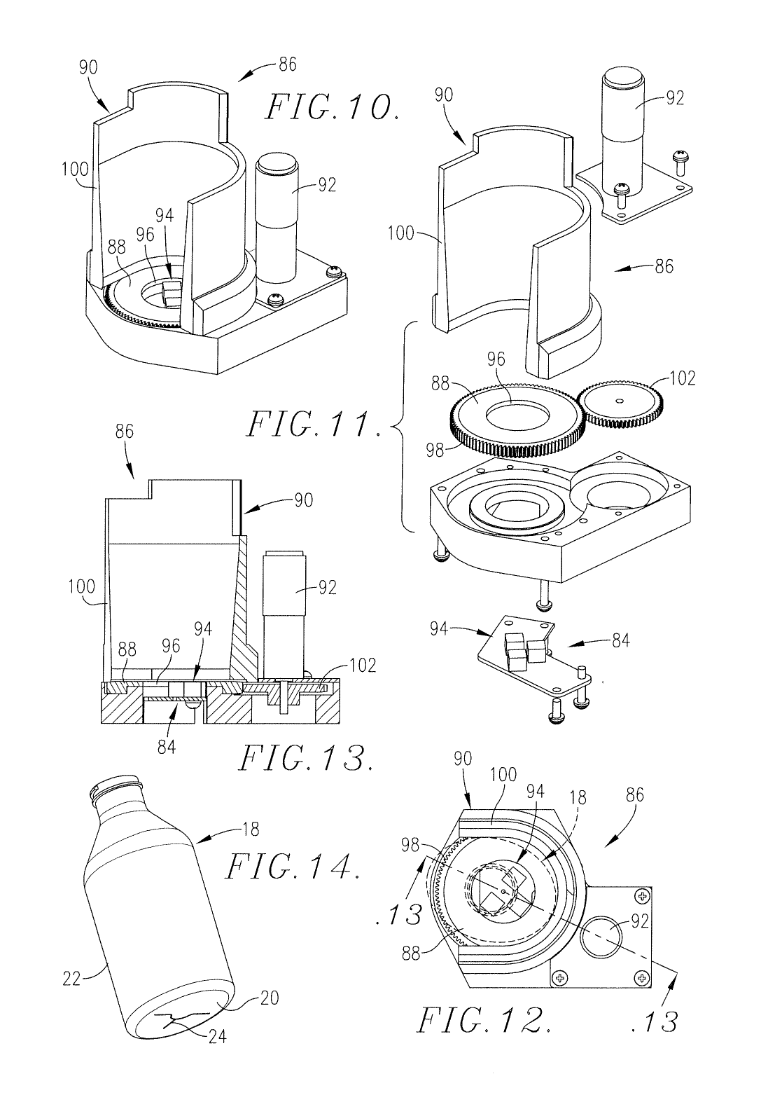

In various embodiments, the pickup platform 56 may also include a rotating unit 86 to properly orient the bottle 18 while the bottle 18 is on the pickup platform 56 waiting to be removed, as seen in FIGS. 10-13. Typically, the rotating unit 86 is necessary when bottles 18 with an oblong shape that include the alignment feature 24 are used. Generally, no further rotation or orienting is needed for regular cylindrical bottles 18. The rotating unit 86 may include a turntable 88, a guide shroud 90, and a drive motor 92. The rotating unit 86 may also include a second sensor 94 to determine the orientation of the bottle 18, as discussed below. The turntable 88 may be generally disc-shaped with an opening 96 around the center of the turntable 88. Some embodiments of the turntable 88 may further include a plurality of evenly distributed teeth 98 on the circumference of the turntable 88. The turntable 88 may rest on the pickup platform 56 over the second sensor 94, such that when a bottle 18 is present on the platform 56, the bottle 18 is positioned primarily on the turntable 88. Since the turntable 88 includes the opening 96, there is an optically clear path from the second sensor 94 to a bottle 18 when the bottle 18 is present on the turntable 88. Furthermore, the second sensor 94 remains stationary as the turntable 88 and the bottle 18 are rotated. In addition, the second sensor 94 may include the same sensing components as discussed above for the first sensor 84.

The guide shroud 90 generally maintains the position of the bottle 18 on the turntable 88, such that the bottle 18 is roughly centered on the turntable 88 as the bottle 18 is being rotated, thus helping to ensure that the alignment feature 24 may be detected. The guide shroud 90 may be attached to the surface of the pickup platform 56 and may include a single curved upstanding side wall with a substantially U-shape cross section. The guide shroud 90 surrounds at least a portion of the circumference of the turntable 88.

The drive motor 92 is generally configured to provide rotation for the turntable 88. The drive motor 92 may include any type of motor, such as alternating current (AC), direct current (DC), stepper, etc., that can provide mechanical rotation when given an electrical or electronic signal from the controller 16. The drive motor 92 may be coupled through a driving gear 102 with the turntable 88, such that rotation of the drive motor 92 causes rotation of the turntable 88. Alternatively, the drive motor 92 may be directly coupled or belt coupled to the turntable 88.

When the bottle 18 is first received on the pickup platform 56, the drive motor 92 of the rotating unit 86 may rotate the bottle 18 for a full revolution (360°) so that the second sensor 94 may identify the alignment feature 24 of the bottle 18. Once the alignment feature 24 is identified, the drive motor 92 may rotate the bottle 18 to the proper orientation to be handled by external equipment. The rotating unit 86 may include intelligent circuitry or mechanisms to automatically energize the drive motor 92 to rotate the turntable 88 until the second sensor 94 detects the alignment feature 24 and to automatically stop the turntable 88 when the alignment feature 24 is detected.

In various embodiments, the bottle dispenser 10 may also include other sensors or sensing elements to detect the presence of a bottle 18 in other locations within the dispenser 10. For example, a sensing element may positioned in the vicinity of the chute 52 to detect the presence of a bottle 18 in the chute 52 being held up by the gating mechanism 54. There may also be a sensing element in the vicinity of the pick wheel 46 to detect the presence of a bottle 18 on the pick arm 44. All additional sensing elements may send a bottle 18 present or bottle 18 absent signal to the controller 16.

The controller 16, as seen in FIG. 15, generally controls the operation of the gating mechanism 54 and the drive source 60 for the pick wheel 46. The controller 16 may receive a first signal from the pickup platform first sensor 84 to indicate the presence or absence of a bottle 18 on the pickup platform 56. In various embodiments, the controller may also receive a second signal from the platform first sensor 84 to indicate whether the alignment feature 24 of a bottle 18 has been detected. The controller 16 may transmit a signal to the gating mechanism 54 to either extend the gate arm 80 or retract the gate arm 80. The controller 16 may also transmit a signal to the drive source 60 to rotate the pick wheel 46 or to stop the pick wheel 46. The behavior of the controller 16 is described in more detail below.

The controller 16 may include one or more of the following: microprocessors, microcontrollers, programmable logic devices (PLDs), field programmable gate arrays (FPGAs), random access memory (RAM), read only memory (ROM), and the like. The controller 16 may also be described by one or more code segments of a hardware description language, such as VHDL or Verilog.

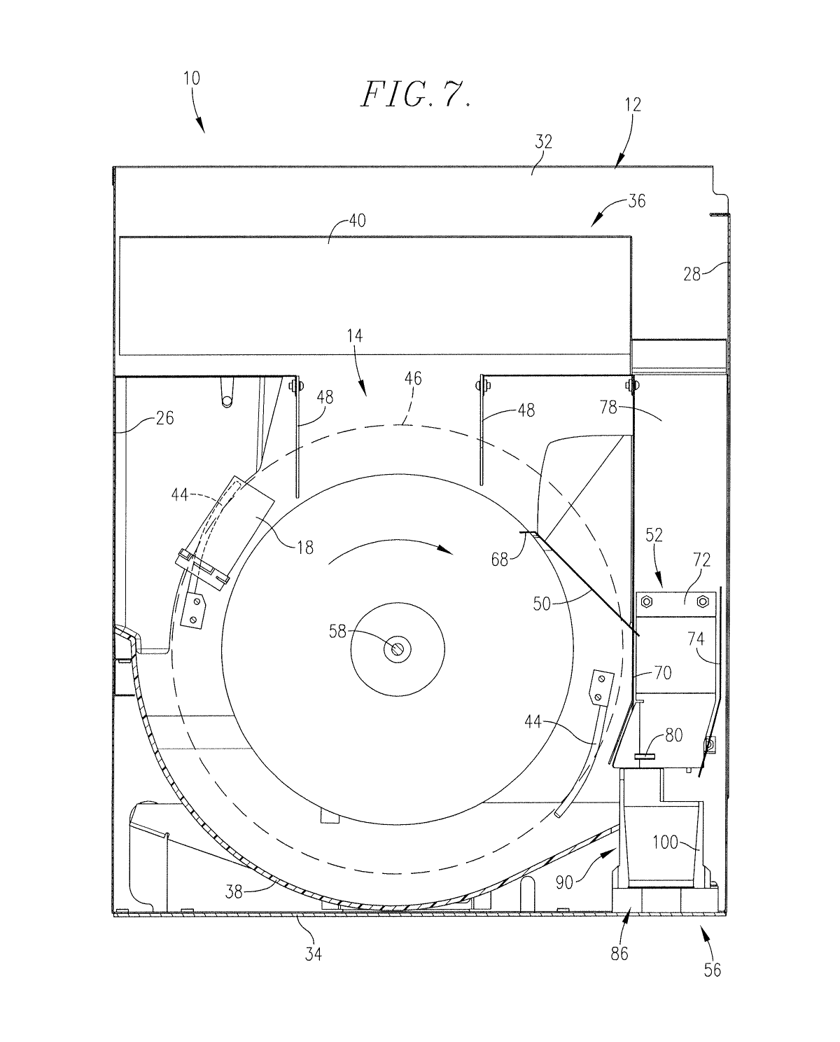

The bottle dispenser 10 may operate as follows, as seen primarily in FIGS. 7-9. It is assumed that there are currently no bottles 18 in the dispenser 10, that the pick wheel 46 is not rotating, that the gate arm 80 is retracted, and that the turntable 88 is not rotating. A plurality of bottles 18, typically a large number, is loaded into the top of the hopper 12. The bottles 18 may fall down the shallow ramp 40 and the steep ramp 42 into the bin 38. The controller 16 may send a signal to the drive source 60 to rotate the pick wheel 46. In various embodiments, the signal to the drive source 60 to rotate the pick wheel 46 may be initiated by an operator. The slope of the bin 38 directs the bottles 18 toward the bottle pickup assembly 14 and so that the bottles 18 are roughly aligned to be picked up by the pick arm 44.

Bottles 18 that are oriented such that the longitudinal axis of the bottle 18 is aligned with the longitudinal axis of the pick arm 44 may get picked up by the pick arm 44. As the pick wheel 46 rotates, properly positioned bottles 18 on the pick arm 44 may get more securely positioned by the flaps 48, while bottles 18 that are askew on the pick arm 44 may get knocked off the pick arm 44. While the pick wheel 46 continues to rotate, the bottle 18 may encounter the ramp stub 68 and the dispenser ramp 50 and fall off the arm 44 and onto the ramp 50. From the dispenser ramp 50, the bottle 18 may enter the chute 52. For the first bottle 18 entering the chute 52, the gating mechanism 54 is retracted, because there is not a bottle 18 on the pickup platform 56. Thus, the first bottle 18 falls through the chute 52 and onto the pickup platform 56. If the bottle 18 is of oblong shape and includes an alignment mark, the rotating unit 86 rotates the bottle 18 until the alignment mark is detected as discussed above. The bottle 18 then waits on the pickup platform 56 to be retrieved.

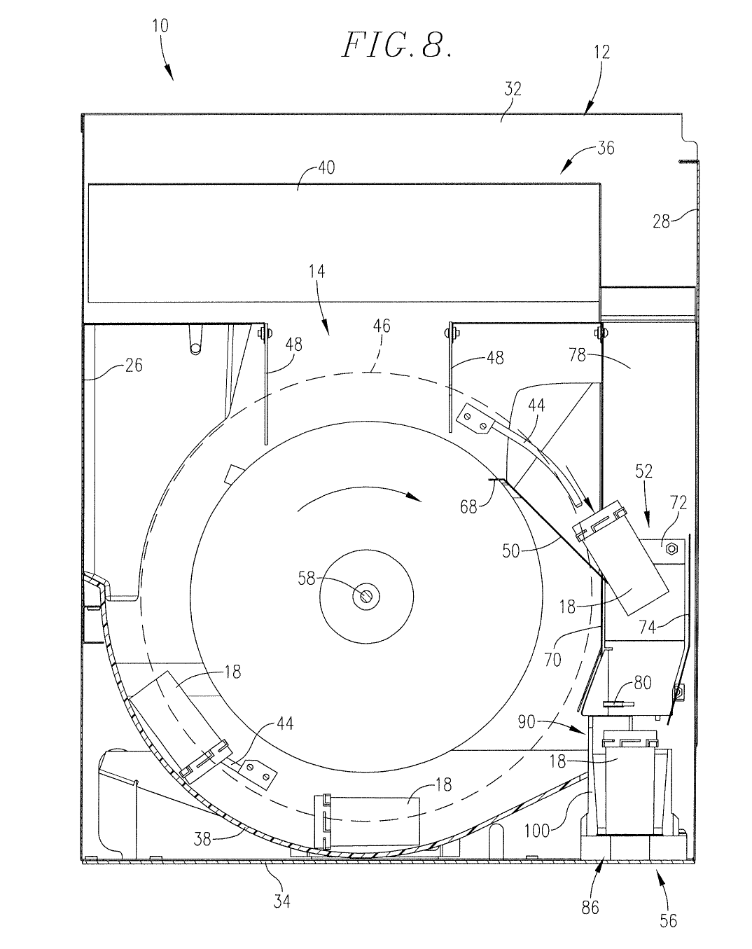

While a bottle 18 is on the pickup platform 56, the controller receives a signal that the bottle 18 is present. In turn, the controller 16 sends a signal to the gating mechanism 54 to extend the gate arm 80. Although, even if there is a bottle 18 in the chute 52, the pick arm 44 still rotates and picks up bottles 18, as best seen in FIG. 8, except when there is both a bottle 18 in the chute 52 and on the platform 56, as described in more detail below. Once the bottle 18 is removed from the pickup platform 56, the first sensor 84 sends a signal to the controller 16 that the bottle 18 is no longer present. Accordingly, the controller 16 may send a signal to the gating mechanism 54 to retract the gate arm 80.

If a first bottle 18 is on the pickup platform 56, the gate arm 80 of the gating mechanism 54 is extended to prevent a second bottle 18 from landing on the first bottle 18 and perhaps knocking both bottles 18 off the platform 56. It is desirable to prevent bottles 18 from stacking up within the chute 52 and on the dispenser ramp 50. However, it is also desirable for the bottle dispenser 10 to maintain a supply of bottles 18 that are ready to be dispensed as quickly as possible. Thus, when there is a first bottle 18 present on the pickup platform 56, a second bottle 18 present in the chute 52 at the gating mechanism 54, and a third bottle 18 retained on the pick arm 44 approaching the chute 52, as best seen in FIG. 9, the controller 16 may send the stop signal to the drive source 60. As a result, this process may maintain a supply of at least three bottles 18 in queue to be dispensed at any given time. Once the bottle 18 is removed from the pickup platform 56, the controller 16 may send a signal to the drive source 60 to start rotating the pick wheel 46 again. Additionally, when the bottle 18 is removed, the controller 16 may send a signal to the gating mechanism 54 to retract the gate arm 80—thereby continuing the dispensing process.

Although the invention has been described with reference to the embodiments illustrated in the attached drawing figures, it is noted that equivalents may be employed and substitutions made herein without departing from the scope of the invention as recited in the claims.

Having thus described various embodiments of the invention, what is claimed as new and desired to be protected by Letters Patent includes the following:

1. A bottle pickup assembly comprising:
a rotatable pick wheel;
at least one pick arm mounted to the pick wheel and configured to retrieve a first medicament bottle from a plurality of medicament bottles as the pick wheel rotates;
a chute to receive the first medicament bottle from the at least one pick arm;
a pickup platform to receive the first medicament bottle from the chute and to retain the first medicament bottle; and
a gating mechanism positioned in the vicinity of the chute and configured to prevent passage of the first medicament bottle from the chute to the pickup platform if a second medicament bottle is present on the pickup platform.

2. The bottle pickup assembly of claim 1, further including at least one flap configured to fully secure medicament bottles that are properly positioned on the pick arm and remove medicament bottles that are not properly positioned on the pick arm.

3. The bottle pickup assembly of claim 1, further including a dispenser ramp positioned between the pick wheel and the chute and configured to transfer medicament bottles from the pick arm to the chute.

4. The bottle pickup assembly of claim 1, further including a sensor configured to detect the presence of any medicament bottle on the pickup platform.

5. The bottle pickup assembly of claim 1, further including a drive shaft coupled to the pick wheel and a drive motor coupled to the drive shaft and configured to rotate the pick wheel.

6. The bottle pickup assembly of claim 1, wherein the pick wheel stops rotating if the second medicament bottle is present on the pickup platform, the first bottle is present in the chute, and a third bottle is retained on the at least one pick arm approaching the chute.

7. The bottle pickup assembly of claim 1, wherein the pickup platform further includes a rotating unit to properly orient the medicament bottle while the medicament bottle is on the pickup platform.

8. The bottle pickup assembly of claim 7, wherein the rotating unit includes a turntable configured to be rotated while retaining the medicament bottle and a drive motor configured to supply rotation to the turntable.

9. A medicament bottle rotating unit comprising:
a turntable of disc shape with a central opening and configured to be rotated while retaining a medicament bottle that includes an alignment feature;
a drive motor coupled to the turntable and configured to rotate the turntable; and
a sensor positioned near the opening of the turntable and configured to determine the orientation of the medicament bottle by detecting the alignment feature.

10. The medicament bottle rotating unit of claim 9, further including a guide shroud surrounding at least a portion of the circumference of the turntable and configured to center the medicament bottle on the turntable while the turntable is rotated.

11. The medicament bottle rotating unit of claim 9, wherein the turntable may include a plurality of evenly distributed teeth that are coupled with a driving gear that is coupled to the drive motor.

12. The medicament bottle rotating unit of claim 9, wherein the drive motor rotates the turntable at least one revolution to identify the alignment feature of the medicament bottle and further rotates the turntable until the proper orientation of the medicament bottle is achieved.

13. A medicament bottle dispenser, the dispenser comprising:
a hopper configured to receive a plurality of medicament bottles from an external source and roughly align the plurality of medicament bottles to be picked up one at a time; and
a medicament bottle dispenser including—
a rotatable pick wheel;
at least one pick arm mounted to the pick wheel and configured to retrieve a first medicament bottle from a plurality of medicament bottles as the pick wheel rotates;
a chute to receive the first medicament bottle from the at least one pick arm,
a pickup platform to receive the first medicament bottle from the chute and to retain the first medicament bottle, and
a gating mechanism positioned in the vicinity of the chute and configured to prevent passage of the first medicament bottle from the chute to the pickup platform if a second medicament bottle is present on the pickup platform.

14. The medicament bottle dispenser of claim 13, wherein the hopper includes a ramped shelf configured to direct the plurality of medicament bottles to a bin configured to retain the plurality of medicament bottles until they are picked up by the medicament bottle dispenser.

15. The medicament bottle dispenser of claim 13, wherein the medicament bottle dispenser further includes at least one flap configured to fully secure medicament bottles that are properly positioned on the pick arm and remove medicament bottles that are not properly positioned on the pick arm.

16. The medicament bottle dispenser of claim 13, further including a dispenser ramp positioned between the pick wheel and the chute and configured to transfer medicament bottles from the pick arm to the chute.

17. The medicament bottle dispenser of claim 13, wherein the medicament bottle dispenser further includes a sensor configured to detect the presence of any medicament bottle on the pickup platform.

18. The medicament bottle dispenser of claim 13, wherein the medicament bottle dispenser further includes a drive shaft coupled to the pick wheel and a drive motor coupled to the drive shaft and configured to rotate the pick wheel.

19. The medicament bottle dispenser of claim 13, wherein the pick wheel stops rotating if the second medicament bottle is present on the pickup platform, the first bottle is present in the chute, and a third bottle is retained on the at least one pick arm approaching the chute.

20. The medicament bottle dispenser of claim 13, wherein the pickup platform further includes a rotating unit to properly orient the medicament bottle while the medicament bottle is on the pickup platform.
